(19) United States
(12) Patent Application Publication
(10) Pub. No.: US 2012/0214106 A1
(43) Pub. Date: Aug. 23, 2012

(54) CHEMICAL LOOPING COMBUSTION

(76) Inventors: SONG SIT, Calgary (CA); Wei-Ping Pan, Bowling Green, KY (US); Yan Cao, Bowling Green, KY (US)

(21) Appl. No.: 13/272,647

(22) Filed: Oct. 13, 2011

Related U.S. Application Data
(60) Provisional application No. 61/392,764, filed on Oct. 13, 2010.

(51) Int. Cl. F23C 10/01; C09K 3/00; F23C 13/00

(52) U.S. Cl. 431/7; 252/183.14

(57) ABSTRACT

A chemical looping combustion process for producing heat or steam or both from a hydrocarbon fuel. A metal oxide oxygen carrier is reduced from an initial oxidation state in a first reduction reaction with a hydrocarbon fuel to provide CO₂, H₂O, heat, and a reduced metal or metal oxide having a first reduced state, the first reduced state lower than the initial oxidation state, and then the reduced metal or metal oxide from the first reduced state is further reduced in a second reduction reaction with additional hydrocarbon fuel to provide CO₂, H₂O, heat, and a further reduced metal or metal oxide having a second reduced state, the second reduced state lower than the first reduced state. The further reduced metal or metal oxide is oxidized, substantially back to the initial oxidation state with air to produce N₂, O₂, and heat.

### CROSS REFERENCE TO RELATED APPLICATIONS

This application claims the benefit of priority of U.S. Provisional Patent Application No. 61/392,764 filed Oct. 13, 2010, which is incorporated herein by reference in its entirety.

### FIELD

The present disclosure relates generally to the generation of heat and power. More particularly, the present disclosure relates to the generation of heat and power utilizing a chemical looping combustion process.

### BACKGROUND

Combined heat and power (CHP) is also known as cogeneration or simultaneous production of two secondary energies, which in the present case are steam and electricity.

CLC had its genesis in the 1950s for the purpose of producing pure CO₂ (Reference No. 1: Lewis, W. K. and E. R. Gilliland, Production of pure carbon dioxide S.O.D. Company, Editor). Interests in CLC rebounded three decades later (Reference No. 2: Nakano, Y., et al., characteristics of Reduction and Oxidation Cyclic Process by Use of a α-Fe₂O₃ Medium, Iron & Steel Journal of Japan, 1986, 72: p. 1521-1527) as a result of the then emerging concerns of anthropogenic emission of CO₂ and its impact on global temperature. In the last 15 years, CLC has attracted a lot of research interests as it represents potentially a lower cost option to generate CHP with carbon capture vis-à-vis solvent, absorbent or adsorbent based post combustion carbon capture (PCC) technologies.

Lyngfelt et al. provided a recent review of the state of the art of CLC (Reference No. 3: Lyngfelt, et al., Chemical-Looping Combustion—Status of Development, 9^{th} International Conference on Circulating Fluidized Beds (CFB-9), May 13-16, 2008, Hamburg, Germany). Their review focused on oxygen carrier compositions and their respective performance in CLC. There were also substantial discussions respecting CLC using natural gas and the various applications there from, such as Chemical Looping Reforming (CLR) to generate synthesis gas (a mixture of H₂ and CO) or hydrogen. There were some references to CLC with solids.

While there has been some talk of scaling up CLC to a demonstration size of 1 to 10 MW (Reference No. 5, Miracca, I, et al., The CO₂ Capture Project (CCP): Results from Phase II (2004-2009), GHGT-9.) using natural gas, the biggest unit using gaseous fuels is the 120 kW laboratory pilot at the Vienna University of Technology (Reference No. 6, Kolbitsch, P., Chemical looping combustion for 100% carbon capture—Design, operation and modeling of a 120 kW pilot rig, Ph. D. Dissertation, January 2009, Vienna University of Technology).

In the last 5 years, there has been some research respecting solid fuels in CLC. Cao et al. investigated the different oxygen carriers and reactor designs of solid fuel CLC (Reference No. 7, Yan Cao and Wei-ping Pan, Investigation of Chemical Looping Combustion by Solid Fuels. 1. Process Analysis, Energy & Fuel 2006, 20, 1836-1844.7 and (Reference, No. 8, Cao, Y., et al., Investigation of Chemical Looping Combustion by Solid Fuels. 2.Redox Reaction Kinetics and Product Characterization with Coal, Biomass and Solid Waste as Solid Fuels and CuO as Oxygen Carrier, Energy & Fuel 2006, 20, 1845-1854). Their results were based on thermal gravimetric analyses (TGA) using copper oxide but not actual CLC. Leion investigated solid fuel CLC in a single fluidized bed using synthetic iron oxides as well as ilmenite as oxygen carriers (Reference No. 9, Leion, H., Chemical-Looping Combustion with Solid Fuels, Ph. D. Dissertation, 2007, Chalmers University of Technology, Göteborg, Sweden). He simulated CLC by using the same oxygen carrier and alternating oxidation (Air Reactor) and reduction (Fuel Reactor) in this single reactor (i.e., cyclic CLC). One of his results showed that the rate limiting step to completely convert the solid fuels is their gasification in his apparatus. Berguerand described the design and operation of a 10 kW CLC pilot using coal and petroleum coke (Reference No. 10, Berguerand, N. and A. Lyngfelt, Operation of a 10 kWth Chemical Looping Combustor for Solid Fuel—Testing with a Mexican Petroleum Coke, GHGT-9). This pilot CLC consisted of a complex, multi-compartment Fuel Reactor where the solid fuels were directly added to the discharge of metal oxide from the Air Reactor loop seal so that they would mix together physically before dropping into the Fuel Reactor. It does not teach any method of gasifying the solid fuels prior to or after being added to the Fuel Reactor. Some of their results indicate that fuel conversion was about 60%, and there were much higher CO concentrations in the Fuel Reactor flue gas vis-à-vis combustion (Reference No. 10, Berguerand). It would appear that the Fuel Reactor design would require further improvement in order to completely convert the solid fuels.

Shen et al. used a combination of a riser type Air Reactor and a spout-fluid-bed as Fuel Reactor to carry out CLC with coal (Reference No. 11, Shen, L. et al., Experiments on Chemical Looping combustion of Coal with a NiO based Oxygen Carrier, Combustion and Flame, 156 (2009), 721-728.). In another presentation they showed that there was CO₂ in the Air Reactor flue gas indicated that coal char leaked through to the Air Reactor (Reference No. 12, Zhao, C., et al., The Research Activities on Carbon Capture and Storage in Southeast University, China, The 34th International Technical Conference on Clean Coal and Fuel System, the Clearwater Clean Coal Conference, May 31 to Jun. 4, 2009). This leakage was also reflected in CO₂ capture efficiency of less than 80% at the highest operating temperature. It would appear that a fluid-spout-bed may not be a good design for Fuel Reactor and does not teach anything respecting better fuel handling to facilitate fuel utilization.

Pröll et al (Reference No. 13, Pröll et al, A Novel Dual Circulating Bed System for Chemical Looping Processes, AIChE Journal, December 2009, 55(12), 3255-3266) used a dual circulating fluid bed system to carry out CLC with gaseous fuels. Their system included a two-level air injection system within the Air Reactor. This split level air injection does not teach how to inject or co-inject fuel with steam into the Fuel Reactor to effect metal oxide reduction.

Reference to CLC using liquid fuels was in a presentation by Sit (Reference No. 14, Sit, S.P., Chemical Looping Steam Generation, Global Petroleum Conference, Calgary, June, 2009) in 2009, in which he described using copper oxide as oxygen carrier with an unspecified liquid fuel in TGA tests. The results showed complete reduction of copper oxide to copper by this fuel in the tests. However he did not specify the CLC process of using liquid fuel nor state whether actual CLC using liquid fuels would be successful in either cyclic or continuous mode. Subsequently, Gauthier et al. made a presentation at the IFP 1^{st} International Conference on Chemical Looping Combustion March 2010 in Lyon, France, describing experiments with sweet Dodecane and nickel oxide oxygen carriers in a cyclic CLC process (Reference No. 15, Ann Forret, A. Hoteit, Th. Gauthier, Chemical Looping Combustion Process Applied to Liquid Fuels, IFP 1^{st} International Conference on Chemical Looping Combustion, IFP-Lyon Mar. 18, 2010).

Ishida and Jin in U.S. Pat. No. 5,447,024 described a CLC process to generate power, in which high pressure CH₄ was used to reduce nickel oxide to nickel in Reactor 1 while air was moisturized and compressed to high pressure to oxidize the returning nickel to nickel oxide in Reactor 2 (Reference No. 16, U.S. Pat. No. 5,447,024 to Ishida and Jin). Exhaust gases from both reactors were expanded through separate turbines to generate power. Ishida and Jin did not teach anything respecting conventional CLC which is conducted at atmospheric pressure, and does not include gas turbines to generate power from its exhaust gases at atmospheric pressure to make power.

However, Fan Z. et al. speculated in its disclosure (Reference No. 17, US 2009/0020405 by Fan. Z. et al.) that U.S. Pat. No. 5,447,024 would work with liquid or solid fuels. However, Ishida and Jin (U.S. Pat. No. 5,447,024) specified that the gas exhaust from Reactor 1 was directly expanded in a turbine. Their process would not work if the gaseous fuels were replaced by liquid or solid fuels. The latter contain ash and sulphur; any natural ash in the liquid or solid fuel, or residues formed there from as a result of combustion, will erode the turbine blades and render it inoperable. In addition, sulphur oxides would be formed from the sulphur in the fuels during combustion which would result in corrosion damage on process surfaces cooler than acid dew points.

Fan Z. et al. did not describe a Chemical Looping process (Reference No. 17, above) to make synthesis gases. Instead of using an oxygen carrier to supply oxygen in the Air Reactor, oxygen was adsorbed first onto a solid adsorbent in one reactor. The oxygen enriched adsorbent was then delivered to a second reactor in series, where the oxygen was desorbed and reacted with carbonaceous fuels. Fan Z. et al.'s disclosure is different from the concurrent oxidation and reduction of the conventional CLC process.

Thomas et al disclosed a scheme to make hydrogen from the reaction of steam with metal such as iron (Reference No. 18, US 2005/0175533 by Thomas, T. J. et al.). It employed chemical looping in a fashion that is different from conventional CLC. Its Reactor 1 is equivalent to the Fuel Reactor in CLC where the oxygen carrier is reduced to metals. But instead of an Air Reactor, their scheme had Reactor 2 where steam was used instead of air to react with metal from Reactor 1 to produce hydrogen and metal oxide. In their scheme, steam was the source of oxygen instead of air in a conventional CLC, and because they used steam, metal was oxidized while hydrogen was liberated. They would enhance the heat balance of their scheme by adding pure oxygen in Reactor 2 or in the metal oxide transfer line to Reactor 1. They included liquid fuels and an external gasifier which was designed as a partial oxidation unit without using steam, in order to encompass all possibilities. Their scheme did not teach conventional CLC where the metal is oxidized with air in an Air Reactor. Air-metal reaction is a simple oxidation reaction with no gaseous product (nitrogen in air is substantially inert in the Air Reactor) and has different chemistry and kinetics vis-à-vis steam metal reactions. Their scheme did not teach or suggest the use of liquid fuel vis-à-vis gaseous fuels, especially when the liquid fuel has high boiling points, highly aromatic molecular structures, and substantial portions of sulphur and nitrogen. They assumed that liquid fuel would behave the same way as sweet gaseous fuels in the Fuel Reactor or in a partial-oxidation gasifier.

Fan L-S et al. (Reference No. 19, US 2009/0000194 by Fan, L-S. et al.) from the same Institution as Thomas et al. described a similar scheme to manufacture hydrogen. Therefore this disclosure had many issues in common with Thomas et al with respect to CLC as discussed above. While their disclosure focused on coal as fuel, they did include liquid fuels for complete coverage, assuming that they behave in a similar fashion as coal, without teaching the critical issues of using liquid fuels. However, Fan L-S et al. did add an external sulphur removal unit in the partial oxidation gasifier that did not use steam, to handle sulphur in the fuel. This is an implicit teaching that Thomas et al. did not envisage of dealing with complex fuels including liquid fuels.

Anumakonda et al. described a Catalytic Partial Oxidation (CPDX) scheme to react sulphurous liquid hydrocarbons with oxygen but no steam to make hydrogen and carbon monoxide in two reactors in series (Reference No. 20, U.S. Pat. No. 6,221,280 to Amarendra et al.). Its gaseous products would fuel a solid oxide fuel cell system to produce electricity. They emphasized that “ . . . absence of carbon formation in the substantial or essential absence of water in the feed gas mixture”. Their description made an important distinction of partial oxidation of hydrocarbon fuels to produce hydrogen and carbon monoxide with air or oxygen only vis-à-vis synthesis gas production using steam. Their scheme does not inform a CLC process, which also does not need catalyst for either oxidation or reduction reactions.

The reactors may include fluidized bed type ranging from bubbling to pneumatic conveying according to (Reference No. 21, Grace J. R. Contacting modes and behaviour classification of gas-solid two-phase suspensions, Canadian Journal of Chemical Engineering 64, 1986, 353-363.)

The current interest in CLC research is principally concentrated in using gaseous fuels, such as natural gas, synthesis gas, hydrogen or carbon monoxide, in the Fuel Reactor. Also, there are many investigations respecting different recipes of oxygen carriers and their attendant kinetics, and reactor design and modeling to determine the reaction kinetic of the Fuel Reactor for CLC with gaseous fuels.

WO/2011/094512 describes a measurement and control system to regulate primarily the solids flow between an oxidizer and a reducer in a chemical looping combustion process. The air flow is also regulated in part to supply oxygen for the oxidizer and in part to convey solids between the two reactors.

It is therefore, desirable to provide an improved chemical looping combustion (CLC) process.

### SUMMARY

It is an object of the present disclosure to obviate or mitigate at least one disadvantage of previous chemical looping combustion processes.

We are disclosing below a new scheme to generate combined heat and power (CHP) using liquid fuels of a wide range of boiling points. The fuels may contain high amounts of sulphur and other contaminants. It employs chemical looping combustion (CLC) with conventional oxygen carriers, and the present fuel handling schemes of: (1) generating synthesis gases from fuel and steam in different proportions in situ or external to, the Fuel Reactor, and (2) injecting into the CLC process at specified locations according to the degree of oxygen carrier reduction; in both cases as a means to achieve improved benefits of metal oxide reduction for improved production of CHP. CLC is a necessary component for this new scheme using liquid fuels. The innovative fuel handling schemes are also necessary to augment CLC so as to make the CHP production at maximum efficiency. Another well known benefit of using CLC is the production of high concentration CO₂ in one of its flue gas streams, which will facilitate CO₂ removal, preventing its release into the atmosphere, without using energy intensive post-combustion CO₂ capture processes.

Liquid fuels are distinctly different from gas or solid fuels. Gaseous fuels are homogeneous chemicals that can react with oxygen carriers directly in the Fuel Reactor in mild conditions. They can be reformed to synthesis gases consequentially of the previous reaction. The synthesis gases reduce the metal oxide oxygen carriers to metal concurrently with the gaseous fuels. They are also usually free of impurities that would result in pollutants such as SO₂, H₂S, particulate matter, mercury or arsenic. Solid fuels do not boil, cannot be vaporized at CLC process conditions, and have a complex physical structure after they are extracted from the ground or produced from other chemicals such as crude oil. They are inert and not reactive until they are processed or purified, i.e., pulverized to power form, washed and de-ashed in the mining and extraction processes, or transformed into gaseous species in combustion or gasification, before they would react with the solid oxygen carriers.

Liquid fuels are produced from petroleum resources, some of which are further refined in refineries. They are also extracted from renewable sources or made from biomass. In the refineries, the manufacturing processes consist of physical processes such as distillation, or de-asphalting, chemical processes such as coking, or catalytic processes such hydrotreating or hydro-cracking. For liquid fuels derived from biomass, fermentation of sugar or cellulose would be used. They would vaporize or pyrolyze to a range of molecules of different reactivity at CLC process conditions.

Both petroleum and biomass derived liquid fuels have been used as feed stocks in a variety of applications, such as in combustion for power generation, in internal combustion engines for transportation, or in manufacturing processes to make chemicals. They are not commonly used as reactants in general or specifically to reduce solid oxides. This is the key difference: it is not obvious they are capable of reacting with the oxygen carriers in the Fuel Reactor of CLC and experiments have to be performed starting with low boiling fuels from pentane to dodecane (Reference No. 15, above).

The present disclosure relates to CLC using liquid fuels of a range of boiling points that contain contaminants such as sulphur and nitrogen. Light Fuels are those that have final boiling point below about 350° C., while Heavy Fuels have final boiling point below about 550° C., at standard temperature and pressure (STP) of 60° F. and 1 atmosphere. They can be directly produced from petroleum resources, or made in refineries from crude oils, or derived from biomass. The present disclosure concerns in part of how to generate synthesis gas in an external Rectifier using Heavy Fuels and steam only without air or oxygen. It also concerns the co-injection of Light Fuels and steam in specific locations in the Fuel Reactor of a CLC process to increase the utilization of Light Fuels and conversion of oxygen carriers to metal. It further describes a newly conceived scheme of tailoring the synthesis gas composition at the injection location to achieve maximum CHP production efficiency. All of the fuel handling means are achieved in a controlled and predictable manner.

Because Light Fuels have low boiling fractions they would be more amenable to in situ (i.e. in the Fuel Reactor) synthesis gas generation. The generation of synthesis gas would be significantly augmented when external steam is co-injected with the Light Fuels. The present process does not require the addition of air or oxygen for synthesis gases generation. After the Light Fuels and steam are co-injected (Co-injectants) into the Fuel Reactor, the Light Fuels are distilled or pyrolyzed to form lighter hydrocarbon gases. These light hydrocarbons gases will react with the oxygen carriers directly to reduce the metal oxide to metals. Alternatively, they may be gasified firstly in situ to form synthesis gases with water vapour formed from the reduction of the oxygen carriers, or with the co-injected steam, which in turn would reduce the oxygen carriers to metals. Synthesis gases have higher diffusivities than light hydrocarbon gases and would reduce the oxygen carriers at a higher rate. This in situ synthesis gas generation may be catalyzed by the oxygen carrier.

The present disclosure addresses (1) in situ synthesis gas generation, (2) specific feed injection locations, (3) amounts of Co-injectants, or (4) the ratio of the Co-injectants. The combination of injection locations with various amounts, or ratios, of Co-injectants are deployed in a controlled manner to gain the separate or concurrent benefits of (1) more complete synthesis gas generation, (2) maximum metal oxide reduction, or (3) increased utilization of injected light fuels or a combination thereof.

The injection points may be selected from one or more of (1), (2), (3), or (4). At each location (1), (2), (3), or (4), the ratio of steam/fuel may be selected. At each location (1), (2), (3), or (4) the fuel or steam may be injected at the same injection point, or may be injected separately.

In a first aspect, the present disclosure provides a chemical looping combustion process for producing heat or steam or both including reducing a metal oxide oxygen carrier from an initial oxidation state in a first reduction reaction between a hydrocarbon fuel and a metal oxide oxygen carrier to provide CO₂, H₂O, heat, and a reduced metal or metal oxide having a first reduced state, the first reduced state lower than the initial oxidation state, further reducing the reduced metal or metal oxide from the first reduced state in a second reduction reaction between additional hydrocarbon fuel and the reduced metal or metal oxide to provide CO₂, H₂O, heat, and a further reduced metal or metal oxide having a second reduced state, the second reduced state lower than the first reduced state, and oxidizing the further reduced metal or metal oxide with air to produce N₂, O₂, heat, and the metal oxide oxygen carrier, the oxidation state of the metal oxide oxygen carrier having been substantially oxidized to the initial oxidation state.

In an embodiment, the first reduction reaction takes place in a Fuel Reactor (FR). In an embodiment, the second reduction reaction takes place in a dip leg of a Fuel Reactor cyclone. In an embodiment, the second reduction reaction takes place in a metal oxide return line of an Air Reactor loop seal. In an embodiment, the second reduction reaction takes place in a Fuel Reactor loop seal.

In an embodiment, the hydrocarbon fuel is injected with steam. In an embodiment, the steam is injected downstream of the hydrocarbon fuel. In an embodiment, the hydrocarbon fuel is a liquid hydrocarbon fuel, pre-processed in a fuel rectifier to generate synthesis gas.

In an embodiment, the metal oxide oxygen carrier includes a copper oxide and a reforming metal. In an embodiment, the reforming metal comprising nickel, cobalt, or iron.

In an embodiment, the ratio of steam to hydrocarbon fuel is varied to select the H:CO ratio. In an embodiment, the ratio of steam to hydrocarbon fuel is varied according to the metal oxide reduction in the FR.

In an embodiment, the hydrocarbon/steam injection at a first location is held constant, and the hydrocarbon/steam injection at a second location is varied.

In an embodiment, the hydrocarbon/steam injection at the second location is optimized to overcome the Knudsen diffusion limit.

In a further aspect, the present disclosure provides an oxygen carrier for a chemical looping combustion process, comprising a copper oxide and a reforming metal.

In an embodiment, the reforming metal comprises nickel, cobalt, or iron.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a schematic of prior art chemical looping combustion in its simplest configuration;

FIG. 2 is a schematic of a chemical looping combustion process of the present disclosure, including in-situ synthesis gas generation for CLC using a light fuel;

FIG. 3 is a detailed schematic of an injection location;

FIG. 4 is a schematic of a chemical looping combustion process of the present disclosure, including a fuel rectifier for CLC using a heavy fuel;

FIG. 5 are examples of operating conditions for a fuel rectifier;

FIG. 6 is a schematic of a dual fuel rectifier for a CLC process of the present disclosure;

FIG. 7 is a schematic of a chemical looping combustion process of the present disclosure, including heat integration of the fuel reactor and the fuel rectifier;

FIG. 8 is a schematic of a chemical looping combustion process of the present disclosure, including FGD for sour heavy fuel;

FIG. 9 is a schematic of a chemical looping combustion process of the present disclosure, including sulphur cleanup in a downcomer between the Fuel Reactor and the loop seal;

FIG. 10 is a schematic of a chemical looping combustion process of the present disclosure, including sulphur cleanup in the oxygen carrier stream upstream of the Air Reactor; and

FIG. 11 is a schematic of a chemical looping combustion process of the present disclosure, in a debottlenecking or trouble-shooting example.

### DETAILED DESCRIPTION

Generally, the present disclosure provides a chemical looping combustion process for the generation of combined heat and power.

Chemical Looping Combustion

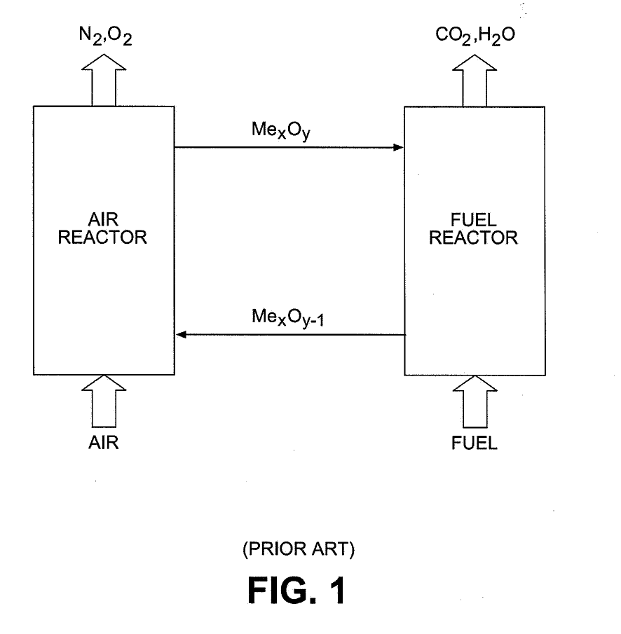

FIG. 1 is a schematic of prior art chemical looping combustion in its simplest configuration. In essence, CLC replaces conventional one-step fuel combustion with two concurrent reactions in two separate, side by side reactors. It uses metal oxide oxygen carriers to provide oxygen to combine with the carbon and hydrogen in the fuel injected without variation simply into the Fuel Reactor, to form CO₂ and H₂O. The metal oxide could be completely or partially reduced to metal or oxide of lower oxidation state (i.e. MeₓO_{y-1}). The oxygen carriers are then returned to the Air Reactor where they are oxidized with air back to metal oxide (i.e. MeₓO_{y}). When the reactions in the Fuel Reactor proceed to completion, CO₂ exists in almost pure form in Fuel Reactor's off gases (after water vapour is condensed and removed) and can be recovered or captured directly without further processing. In contrast, a solvent, absorbent or adsorbent, is required in add-on conventional post combustion carbon capture (PCC) processes to separate CO₂ from other gases in the combustion flue gases from conventional combustion. In the case of PCC solvent processes, a significant amount of energy is required to regenerate the solvent for re-use, ranging from an additional 11 to 40 percent of input energy to the power generators (Table 8.1 in IPCC Special Report on Carbon Dioxide and Storage, Reference No. 4, above). In comparison, there are no such energy penalties in CLC.

Light Liquid Fuel

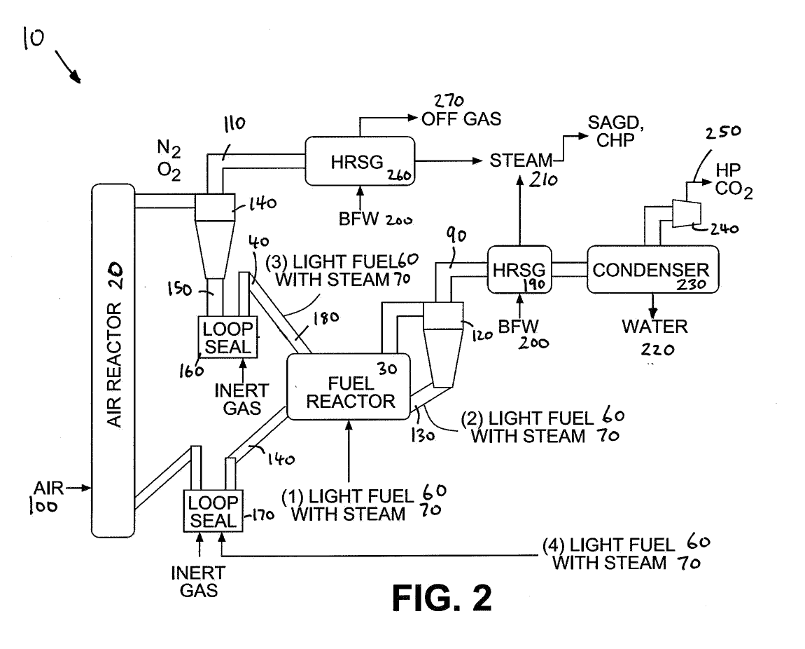

FIG. 2 shows one configuration of the in situ generation of synthesis gas for light fuels using one or more injection points (without showing the different amounts of co-injectants or the co-injectant ratios).

A chemical looping combustion (CLC) process 10 includes an air reactor 20, a fuel reactor 30, and an oxygen carrier loop 40. A fuel 50, is added to the CLC process 10 and may include a light fuel 60 with steam 70. An oxygen carrier 80 (e.g. MeₓO_{y}) provides oxygen to combine with the carbon and hydrogen in the fuel 50 to produce fuel reactor flue gases 90 and the oxygen carrier 80 is at least partially reduced in the fuel reactor 30 to a lower oxidation state (e.g. MeₓO_{y-1}).

The fuel reactor flue gases 90 may include CO₂ and H₂O as hot vapour. A fuel reactor flue gas separator, for example a fuel reactor cyclone 120 may be used to separate the oxygen carriers 80 and the fuel reactor flue gases 90. The oxygen carriers 80 from the fuel reactor cyclone 120 are returned to the fuel reactor 20 via a fuel reactor cyclone dip leg 130.

The oxygen carriers 80 are returned to the air reactor 20 via the oxygen carrier loop 40. Oxygen, for example provided by air 100 to the air reactor 20 is used to oxidize the oxygen carriers 80 back to metal oxide (i.e. MeₓO_{y}). Air reactor flue gases 110 include N₂ and O₂ as hot vapour. An air reactor flue gas separator, for example an air reactor cyclone 140 may be used to separate the oxygen carriers 80 and the air reactor flue gases 110. The metal oxide oxygen carriers 80 from the air reactor cyclone 140 are returned to the oxygen carrier loop 40 via an air reactor cyclone dip leg 150.

An air reactor loop seal 160 and a fuel reactor loop seal 170 are provided in the oxygen carrier loop 40 to seal the air loop from the fuel loop. The portion of the oxygen carrier loop 40 between the air reactor loop seal 160 and the fuel reactor 30 is referred to herein as the metal oxide return line 180.

As disclosed herein, the fuel 50 (in this embodiment light fuel 60 with steam 70) may be provided into the CLC process 10 at one or more locations. The injection location may include one or more of the fuel reactor 30 (location 1), the fuel reactor cyclone dip leg 130 (location 2), the metal oxide return line 180 (location 3), or the fuel reactor loop seal 170 (location 4) as shown in FIG. 2.

At location 1, the oxygen carrier 80 is fluidized in a constantly agitated mode or state, promoting good mixing between the oxygen carrier 80 and the fuel 50 (in this case light fuel 60 with steam 70). This is conducive to the reduction of the oxygen carrier 80.

At location 2, the fuel 50 (in this case light fuel 60 with steam 70) encounter downward flow of the oxygen carrier 80. At this location, some of the metal oxide oxygen carriers 80 may have been partially reduced. The addition of light fuel 60 with steam 70 therein increases the reduction to approach complete reduction.

At location 3, the fuel 50 (in this case light fuel 60 with steam 70) encounter oxygen carriers 80 containing the greatest amount of metal oxide which provides more favourable kinetics. At location 3, the oxygen carriers 80 are substantially fully oxidized, as metal oxide (MeₓO_{y}).

At location 4, any remaining unconverted oxygen carrier 80 will be reduced to metals by the fuel 50 (in this case light fuel 60 with steam 70) before returning to the air reactor 20.

The light fuel 60 with steam 70, referred to herein as the co-injectants may be added at one, two, three, four, or even more specific locations (1), (2), (3), (4) as described above or combinations thereof. The light fuel 60 with steam 70 may be provided in equal or different amounts of co-injectants. When more than one location is used, the injection at one location may be held substantially constant while the injection at the other one or more location may be constant, intermittent, or at pre-programmed rate as the reduction of the oxygen carrier 80 dictates. In an embodiment disclosed, the sum total of the various amounts of light fuel 60 with steam 70 would be substantially equal to the total requirement to fully reduce the oxygen carrier 80.

In the present disclosure, the reduction reaction may occur in a number of steps or stages, for example by degrees of reduction. In one embodiment disclosed, for example, one may get 50 percent of the oxygen carrier 80 reduced in the fuel reactor 30, and another 35 percent in the fuel reactor cyclone dip leg 130 and the remaining 15 percent reduction in the fuel reactor loop seal 170. In an embodiment disclosed, the light fuel 60 with steam 70 is provided in a corresponding proportion to support this staged reduction of the oxygen carrier 80.

Fuel

In the present disclosure, the relative amount of co-injectants at the different locations may be varied to generate different ratios of hydrogen to carbon monoxide (H₂:CO).

According to experimental results, the kinetics of hydrogen are faster than carbon monoxide or light hydrocarbon gases, to reduce metal oxide to metal in a chemical looping combustion process. As used herein, light hydrocarbon gases refer to hydrocarbons having one to four carbon atoms, including C₁ (e.g. CH₄), O₂, C₃ and C₄ hydrocarbons as well as olefins formed having two or more carbon atoms, including C₂+ olefins formed in pyrolysis.

Solid fuels are not pyrolyzed and instead are gasified to provide simpler and more reactive gases, mainly H₂ and CO with minor amounts of CH₄ (unlikely to include O₂+), to be used in the fuel reactor 30.

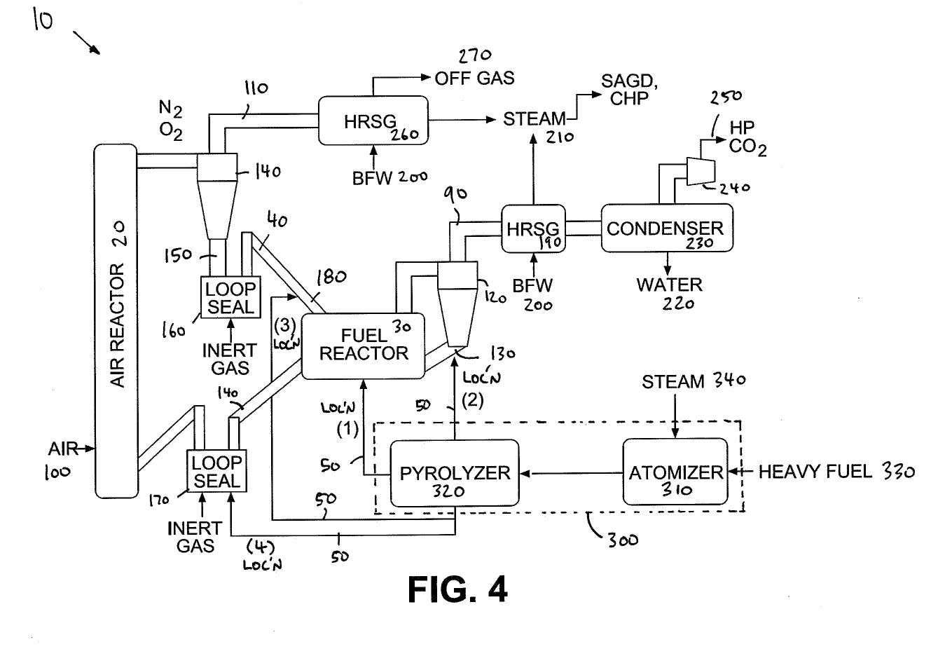

Light liquid fuels may be directly injected into the fuel reactor 30 or one or more of the locations (1), (2), (3), (4) or combinations thereof, and are vaporized and pyrolyzed therein. Light hydrocarbon gases are also formed when heavy fuels are pyrolyzed in the fuel rectifier 300 (see FIG. 4) in order to prevent or reduce coking and promote kinetics of the reduction of the oxygen carrier 80 in the fuel reactor 30.

Thus, by varying the ratio of steam 70 to light fuel 60 in the co-injectants, one can selectively tailor the ratio of hydrogen to carbon monoxide (H₂:CO). at different locations in the chemical looping combustion process 10. As a result, co-injectants producing higher hydrogen content can be injected at locations where it is more difficult to achieve complete reduction of the oxygen carrier 80. In an embodiment disclosed, such locations include location (2), location (4) or both, where Knudsen diffusion is the rate controlling step. Hydrogen has much higher diffusivities and can access the deeper recesses of the oxygen carrier 80. This provides an improvement over simply adding the fuel 50 into the fuel reactor 30. The present disclosure provides complete or improved reduction of the oxygen carrier 80, not limited by the residence time of the oxygen carrier 80 in the fuel reactor 30, or increasing the size of the fuel reactor 30 to increase residence time. In addition, the circulation rate of the oxygen carrier 80 may be reduced (lowered) while still able to achieve substantially complete reduction of the oxygen carrier 80 in the fuel reactor 30 which by prior design and operation must rely on a relatively high circulation rate of the solid metal oxide oxygen carrier to achieve substantially complete reduction of the oxygen carrier 80. This results in faster kinetics and more energy efficient reduction of the oxygen carrier 80. The present disclosure provides complete or improved reduction of the oxygen carrier 80 utilizing smaller reactors (e.g. fuel reactor or air reactor or both) or a lower oxygen carrier 80 circulation rate or both.

Heat Recovery

In an embodiment disclosed, heat may be recovered from the air reactor flue gases 110 or the fuel reactor flue gases 90 or both.

In an embodiment disclosed, the fuel reactor flue gases 90 pass through a heat recovery steam generator 190 to heat boiler feed water (BFW) 200 to provide steam 210. Water 220 may be removed from the fuel reactor flue gases 90, for example by a condenser 230, leaving a substantially pure CO₂ stream, which can be compressed, for example by a compressor 240 to provide high pressure CO₂, ready for transport, further processing, storage or sequestration, for example for carbon capture and storage (CCS).

In an embodiment disclosed, the air reactor flue gases 110 pass through a heat recovery steam generator 260 to heat boiler feed water (BFW) 200 to provide steam 210. The cooled air reactor flue gases 110 become off gas 270. The steam 210 may be used for a variety of purposes, for example, but not limited to industrial processes, such as the co-generation of combined heat and power (CHP) or use in enhanced oil recovery, such as heavy oil or bitumen recovery processes, such as in situ processes including steam assisted gravity drainage (SAGD).

The oxygen carrier 80 is substantially oxidized within the air reactor 20. As the light fuel 60 with steam 70 is injected at locations (1), (2), (3), (4), or combinations thereof, the oxygen carrier 80 is further reduced as the fuel is oxidized.

Sequential Injection

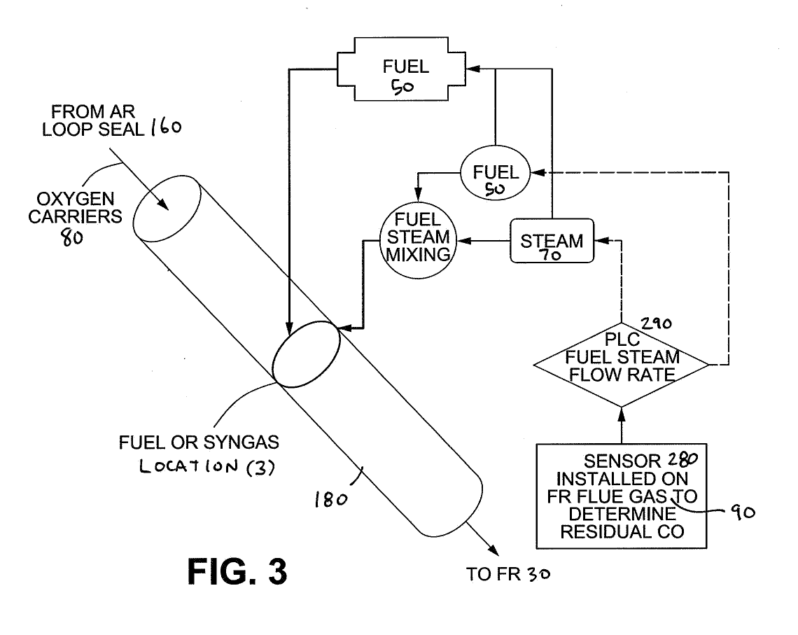

In an embodiment disclosed, the relative injection locations for the co-injectants may be varied. Referring to FIG. 3, injection at location 3 in the metal oxide return line 180 for example, showing the alternatives of direct injection of fuel and steam or fuel and steam are pyrolyzed in a fuel rectifier 300 (see FIG. 4) before injection.

For any one or more of the locations (1), (2), (3), or (4) or a combination thereof, the fuel 50 may be injected upstream relative to the injection of the steam 70. The fuel 50 can absorb heat for its at least partial pyrolysis, and heavier portion(s) of the fuel 50 which has less potential for complete decomposition will be recovered, and then steam 70 can be injected downstream for continued gasification of the pyrolyzed fuel 50. This configuration may be effective in increasing fuel oxidation and to reduce or prevent coke deposit onto the oxygen carrier 80 by the heavier fraction(s) of the fuel 50. Thus, more complex or heavier fuel 50 or fuel residue may be used as fuel 50 for the chemical looping combustion process 10.

In an embodiment disclosed, the completeness of the reduction of the oxygen carrier 80 may be determined by detecting the residual CO in the fuel reactor flue gases 90. A sensor 280 measures the amount of CO in the fuel reactor flue gas 90, and this information is provided to a control system, for example a programmable logic controller (PLC) 290 which makes adjustment to the fuel/steam mix for example by operating one or more control or mixing valves (not shown) to increase or decrease, as the case may be, the degree of reduction of the oxygen carrier 80 in the fuel reactor 30 or the oxidation of the fuel 50 in the fuel reactor 30.

Gaseous Fuels

Aspects of the present disclosure may be used with a gaseous fuel, such as hydrocarbon fuels, such as CH₄. The locations (1), (2), (3), or (4) or combinations thereof may be used to inject the gaseous fuel. The gaseous fuel may be injected with or without steam depending on the metal on the oxygen carrier 80. When the oxygen carrier 80 includes nickel, then steam injection may not be necessary as nickel is a good steam reforming catalyst and CH₄ and water vapour generated in the reduction reaction would be catalyzed to syngas. However, if the oxygen carrier 80 uses iron oxide, then injection of steam may be necessary or beneficial.

Heavy Fuels

Heavy Fuels, such as No. 2 or No. 6 oil, asphalt or bitumen have relatively high final boiling points. The high-boiling fractions or the whole heavy fuels will not be distilled into lighter hydrocarbons available for synthesis gas formation if they are simply injected into the fuel reactor 30. Also, this non-distillable fraction may be thermally cracked to form coke if not handled correctly. The coke could coat the oxygen carriers 80 which could impede the reduction of metal as well as being oxidized to CO₂ when the coke coated oxygen carrier 80 is returned to the air reactor 20.

Fuel Rectifier

The present disclosure includes an external device to enhance syngas generation with the specific injection locations in the chemical looping combustion process 10. FIG. 4 illustrates a fuel rectifier 300 which includes an atomizer 310 and a pyrolyzer 320, including the four (4) locations for injection of fuel 50 as above. In this disclosure, the fuel injected or otherwise provided into the chemical looping combustion process 10 is synthesis gas. A heavy fuel 330 and steam 340 (without oxygen) are provided to the atomizer 310. The atomizer 310 includes nozzles sized for different heavy fuels 330 as a function of their respective density and viscosity. The pressure, temperature, and feed rate are selected such that the heavy fuel 330 and steam 340 are atomized into the correct range of droplet sizes. The heavy fuel 330 is heated in the pyrolyzer 320 to a level where the heavy fuel 330 and the steam 340 react to form synthesis gas (H₂:CO). The operating temperature of the fuel rectifier 300 is selected as a function of the heavy fuel 330. With the fuel rectifier 330, one can achieve high concentrations of hydrogen, consistently at two times the CO, and low levels of CO₂ and light hydrocarbon gases such as methane, ethane and olefins.

One can also operate the fuel rectifier 330 to vary the ratio of hydrogen to carbon monoxide in the syngas.

### Fuel Rectifier (Atomizer/Pyrolyzer) Operation

### Examples

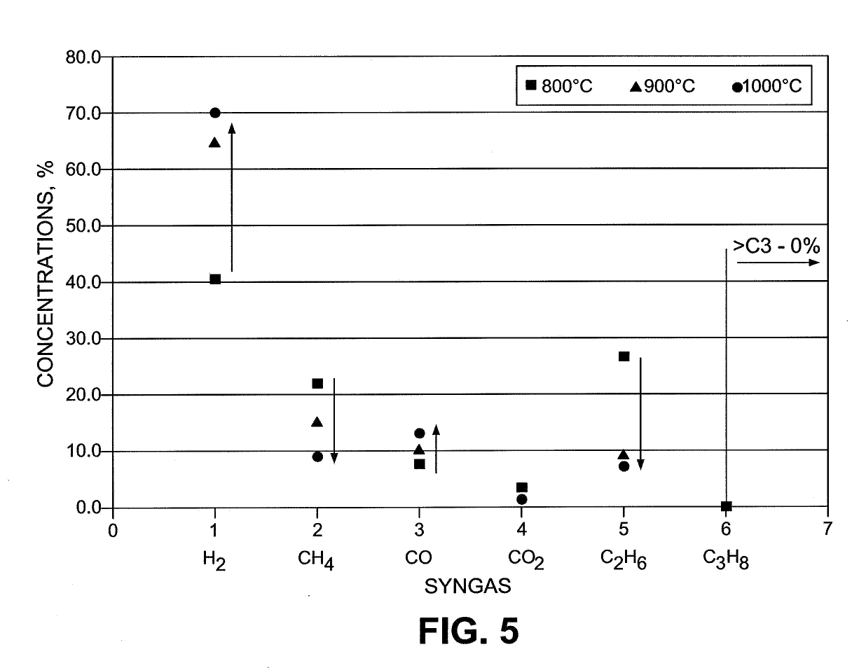

Referring to Table 1 and FIG. 5, the composition of syngas, including the H₂:CO ratio may be selectively controlled, dependent on the operating temperature of the fuel rectifier 300 (Table 1 includes the temperature, H₂ concentration, CO concentration, and H₂:CO ratio from FIG. 5). In this example, the fuel is asphalt and the asphalt is pressurized to between about 25 psi to 80 psi and then atomized at atmospheric pressure with the atomizer 310. The atomized asphalt and steam are then pyrolyzed in the pyrolyzer 320.

TABLE 1

| Temperature ° C. | H₂ | CO | H₂:CO |
|---|---|---|---|
| 800 | 40% | 8% | 5 |
| 900 | 65% | 10% | 6.5 |
| 1,000 | 70% | 12% | 5.8 |

Operating at 900° C. provides a higher H₂:CO ratio, of 6.5, relative to the 5.0 at 800° C. and the 5.8 at 1000° C. One may note the significant increase in H₂ when comparing operation at 900° C. to operation at 800° C.

In another example, Heavy Sour Fuels having greater than 0.5% wt sulphur produced syngas having hydrogen sulphide only at ppm levels. The addition of the fuel rectifier 300 reduces or eliminates coking within the chemical looping combustion (CLC) process 10.

Synthesis Gas Injection

The synthesis gas produced by the fuel rectifier 300 may be injected at locations (1), (2), (3) or (4) or in various combinations where the synthesis gas injection amounts are equal or in various proportions to achieve the optimum or improved reduction of the oxygen carrier 80. When more than one injection location is in use, the injection rate can be held constant at one location while the rate(s) at other location(s) can be constant, intermittent or set according to pre-selected rates (e.g. programmed) or rates determined in real-time (e.g. calculated from measured operating conditions or other parameters) as the reduction of metal oxide or other operating parameters dictate.

Syngas/H₂ Rich Syngas

The fuel rectifier 300 may be used to generate synthesis gas of different ratios of hydrogen to carbon monoxide. In an embodiment of this disclosure, the chemical looping combustion (CLC) process 10 may use more than one fuel rectifier 300. In one exemplary arrangement, the pyrolysis temperature can be regulated or selected to produce different ratios of H₂ to CO. In addition, the ratio of steam to fuel may also be increased to further increase the H₂:CO ratio.

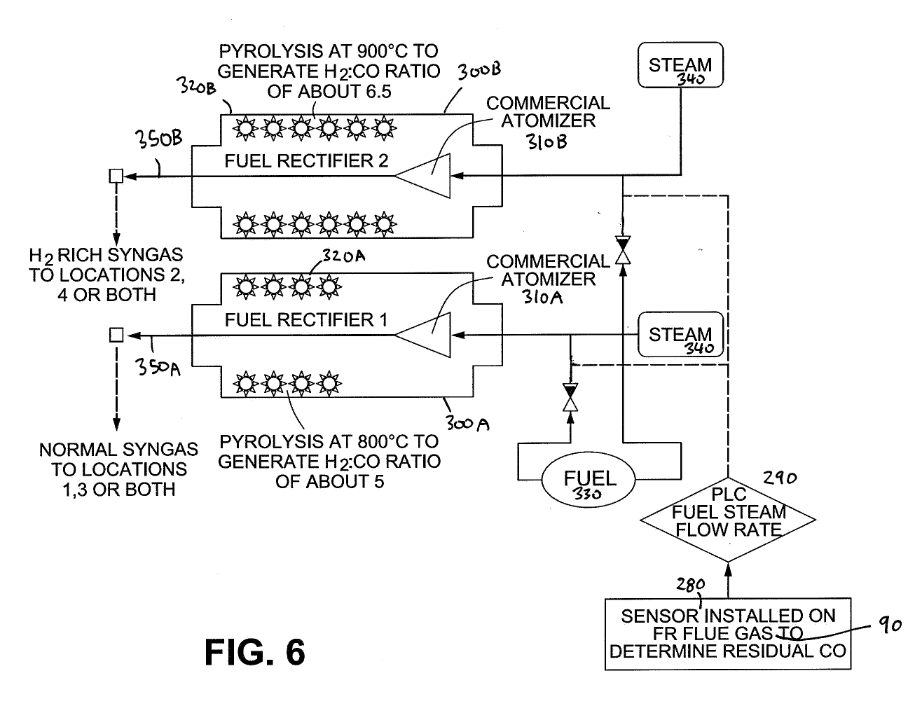

Referring to FIG. 6, a first fuel rectifier 300A may be configured and operated to produce a first synthesis gas 350A having a base or ‘normal’ H₂:CO ratio. A second fuel rectifier 300B may be configured and operated to produce a second synthesis gas 350B having a higher H₂:CO ratio, the H₂ rich syngas having a H₂:CO ratio greater than the base H₂:CO ratio. As above, the first fuel rectifier 300A includes a first atomizer 310A and a first pyrolyzer 320A, and the second fuel rectifier 300B includes a second atomizer 310B and a second pyrolyzer 320B.

In an embodiment disclosed, the first fuel rectifier 300A may be operated at about 800° C. to produce syngas having a H₂:CO ratio of about 5.0 (normal syngas). In an embodiment disclosed, the second fuel rectifier 300B may be operated at about 900° C. to produce syngas having a H₂:CO₂ ratio of about 6.5 (H₂ rich syngas).

As described earlier in respect of light fuels, one can inject the synthesis gas 350B that has higher amounts of hydrogen at location (2) or (4) or both, where Knudsen diffusion is the rate controlling step. Hydrogen has a higher diffusivity than carbon monoxide and can access the inner pores of the partially reduced oxygen carrier 80 and effect more complete reduction to metal. The base or normal syngas 350A may be injected at locations (1) or (3) or both.

Oxygen Carriers

Conventional oxygen carriers can be used in the chemical looping combustion process 10 with light fuel or heavy fuel. In the former, in order to facilitate in situ syngas generation, an oxygen carrier 80 containing nickel oxide in addition to the primary metal is also acceptable. In addition, the oxygen carrier 10 may have a different support or reactive metal embedded.

Nickel, cobalt and iron are known reforming metals, in descending order of reforming ability. It would be advantageous to include one or more of these reforming metals in the oxygen carrier 10 loaded with copper oxide. Such bi-metallic oxygen carriers 80 could provide improved reactivity and phase stabilization, and could be manufactured in at least two ways. One way is to use a natural mineral that contains nickel and then load it with copper oxide. Alternately one can use both copper and nickel salt solutions and load them into a catalyst support and then calcine it to convert the copper and nickel solutions to oxides.

Heat Integration

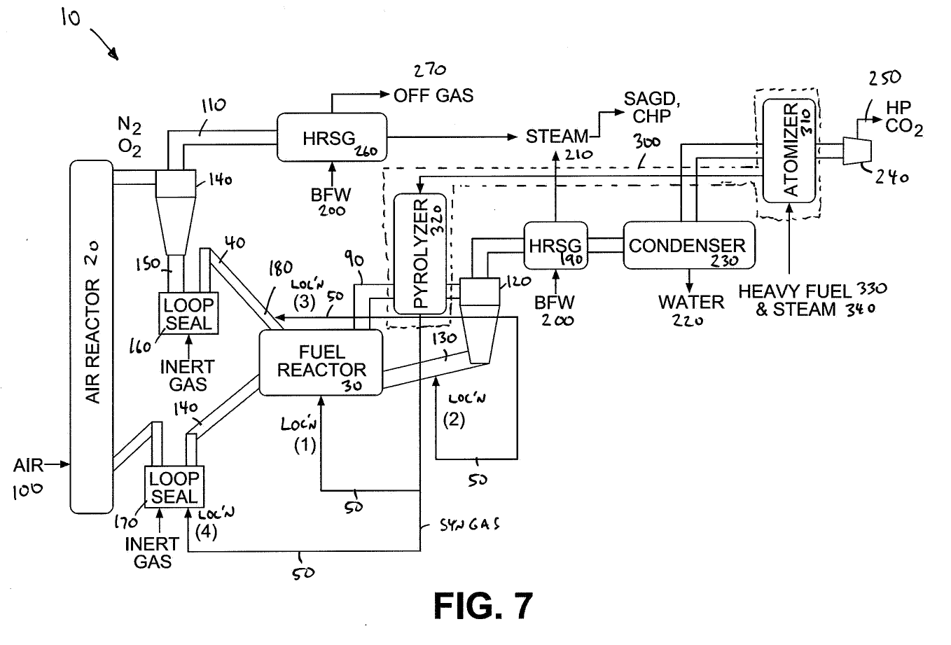

In a further configuration of the fuel rectifier 300, heat integration can be achieved with the chemical looping combustion process 10 flue gases. FIG. 7 illustrates one heat integration arrangement with the fuel reactor 30 for heavy fuels. For more energy efficient CO₂ compression, the inlet gas temperature to the compressor should be low. Therefore the temperature of the fuel reactor flue gases 90 are lowered by heat exchanging with the fuel rectifier 300 in two consecutive steps. First, the fuel reactor flue gases 90 directly heats the pyrolyzer 320 prior to the fuel reactor cyclone 120. Then the atomizer 310 is heated by the de-hydrated flue gases after they are cooled down further by the HRSG 190 and condenser 230. The heat recovery steam generator (HRSG) 190 sizing and output of steam 210 will be reduced as the heat available is now reduced. Alternative integration with the air reactor 20 is possible and is not illustrated here. Although the pyrolyzer 320 and atomizer 310 may be located in different flue gas streams, they are still considered (together) to operate as the fuel rectifier 300. The syngas from the fuel rectifier 300 may be provided into the chemical looping combustion process 10 at one or more of location (1), (2), (3), (4), or combinations thereof.

Sour Heavy Liquid Fuel

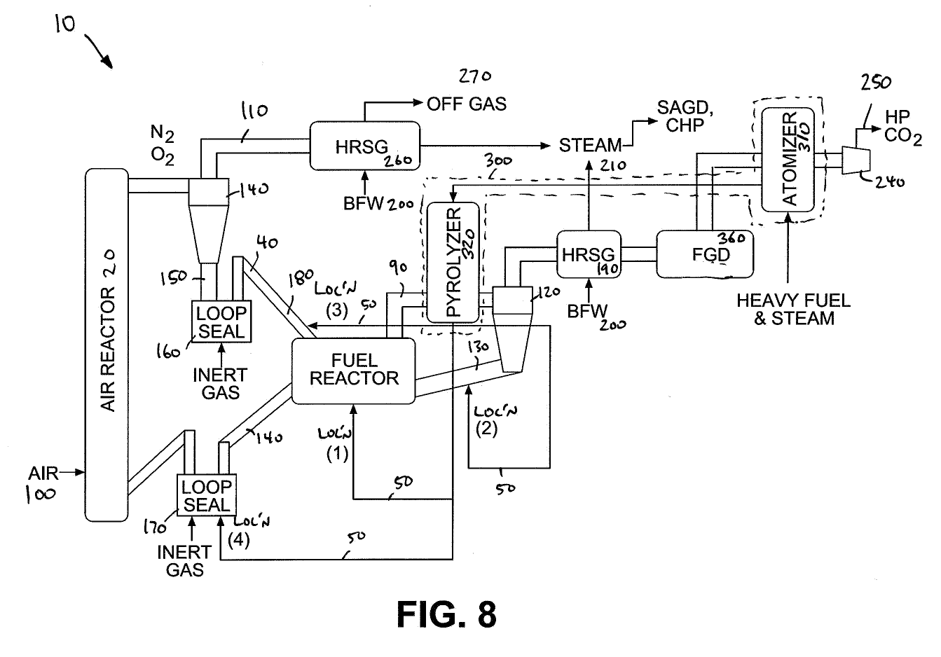

FIG. 8 is an example of a chemical looping combustion (CLC) process 10 including a flue gas desulphurization (FGD) process 360 to remove any sulphur dioxide (SO₂) formed in the fuel reactor 30. The FGD 360 can be of conventional design, known to one ordinarily skilled in the art. The FGD 360 should also be capable of removing H₂₅ from the fuel reactor 30.

Scrubbing Sulphur in Oxygen Carrier

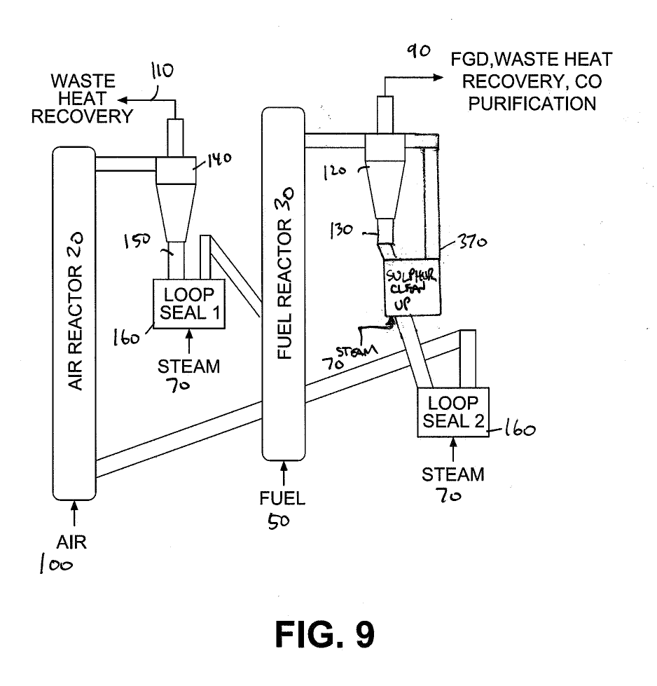

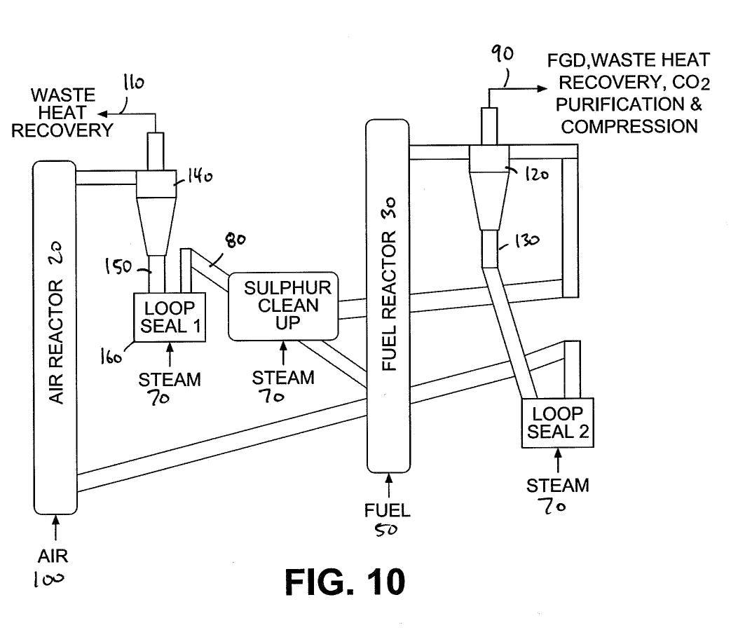

FIGS. 9 and 10 provide examples of flushing the oxygen carrier 80 with steam 70 prior to the oxygen carrier 80 entering the air reactor 20. FIG. 9 depicts one arrangement for removing Sulphur from the fuel reactor 30, and FIG. 10 depicts another arrangement for removing Sulphur from the fuel reactor 30.

In certain start-up, upset, or other adverse operating conditions, sulphur may be deposited on the oxygen carrier 80 in the oxygen carrier loop 40, for example in the fuel reactor 30. In that condition, the oxygen carrier 80 may be steam flushed prior to entering the air reactor 20. If the oxygen carrier 80 is not flushed with steam, then SO₂ will form in the air reactor 20, and then the air reactor off gas 270 must be scrubbed to remove that SO₂ requiring an additional flue gas desulphurization (FGD) unit 360. Steam 70 is utilized to strip off any sulphur deposits on the oxygen carrier 80 and keep sulphur in the fuel reactor 30 as SO₂ in a gaseous state to prevent any interaction with the oxygen carrier 80 in the fuel reactor 30. This prevents or reduces degradation of the oxygen carrier 80, maintaining maximum or improved oxygen carrying capacity, and keeping all fuel Sulphur in the fuel reactor flue gas 90.

Referring to FIG. 9, steam 70 is introduced into a downcomer 370 between the fuel reactor 30 and the fuel reactor loop seal 170. The sulphur is scrubbed from the oxygen carrier 80 and the steam 70 and sulphur are conveyed into the fuel reactor cyclone 120.

Referring to FIG. 10, steam 70 is introduced into the oxygen carrier loop 40 upstream of the air reactor 20. The sulphur is scrubbed from the oxygen carrier 80 and into the fuel reactor flue gas 90.

The fuel reactor flue gases 90, now containing at least some sulphur must undergo some treatment, for example flue gas desulphurization (FGD) 360. In an embodiment disclosed, the sulphur may be removed from the fuel reactor flue gas stream 90 to meet CO₂ pipeline specifications, for example as CaSO₄ in a FGD unit 360.

### Debottlenecking/Trouble-Shooting

### Example

In any combustion process, 100 percent fuel utilization is an important objective. When using chemical looping combustion, fuel utilization may be limited by the oxygen carrier 80 or reactor design. These limitations may be due to the type or the amount of metal loaded in the oxygen carrier 80, reactor dimensions, for example fuel reactor 30 dimensions, and hence the residence time of the fuel, or the circulation rate of the oxygen carrier 80 within the oxygen carrier loop 40, or a combination thereof.

It is possible that despite using the maximum loading of metal in the oxygen carrier 80, or the maximum solid circulation permissible in the reactors (fuel reactor 30 or air reactor 20), there may still be excessively high un-burned fuel in the fuel reactor flue gas 90.

One option is to de-rate the HRSG 190, e.g. to reduce fuel input to the CLC process 10 and thus lower the combined heat and power (CHP) output. Another option is to re-design the reactors, for example the fuel reactor 30, to provide for a longer residence time. A further option is to change the type of metal loaded in the oxygen carrier 80. Each of these options may be undesirable (or impractical) due to excessive cost or design restraints. The present disclosure provides another option, deployed with the existing oxygen carriers 80 and as built reactors, for example fuel reactor 30, to eliminate or reduce incomplete fuel utilization.

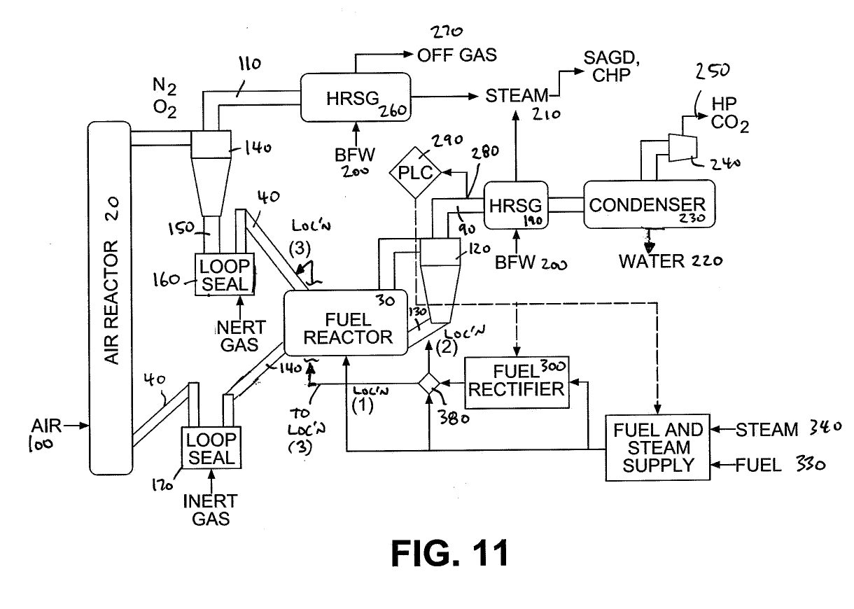

Referring to FIG. 11, rather than injecting 100 percent of the fuel at location (1), the injection amounts are controlled by the programmable logic controller (PLC) 290 or other control system. The PLC 290 receives fuel reactor flue gas 90 composition information from the sensor 280 or sensors installed in the outlet from the fuel reactor cyclone 120. The PLC 290 sends signals to the fuel and steam supply control. Depending on the level of CO or CH₄ in the fuel reactor flue gas 90, about 10 percent to about 50 percent of the total fuel and steam will be sent either directly to the splitter 380, which then controls the relative amounts of direct fuel and steam injection at locations (2) or (3), or to the fuel rectifier 300. It produces a syngas stream with ratios of H₂:CO that is commensurate with the signal from the PLC 290. This syngas stream is sent to the splitter 380, which controls the relative amounts of syngas injection at locations (2) and (3). The split between location (2) and (3) can range from about 50/50 split to about ⅓ at (2) and ⅔ at (3). The remaining about 50 percent to about 90 percent of the total fuel and steam will be maintained at injection location (1).

General

The performance of the chemical looping combustion loop may be monitored by sampling the gas to measure the H₂O and CO₂ concentrations, or oxygen carrier 80 samples may be withdrawn to measure the rate or state of reduction, or the oxygen carrier circulation rate may be measured (with a higher oxygen carrier circulation rate indicating a less efficient use of the metal in the oxygen carrier 80). Also, as indicated above, the amount of CH₄ or CO in the fuel reactor flue gas 90 may be evaluated.

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

What is claimed is:

1. A chemical looping combustion process for producing heat or steam or both comprising:
reducing a metal oxide oxygen carrier from an initial oxidation state in a first reduction reaction between a hydrocarbon fuel and a metal oxide oxygen carrier to provide CO₂, H₂O, heat, and a reduced metal or metal oxide having a first reduced state, the first reduced state lower than the initial oxidation state;
further reducing the reduced metal or metal oxide from the first reduced state in a second reduction reaction between additional hydrocarbon fuel and the reduced metal or metal oxide to provide CO₂, H₂O, heat, and a further reduced metal or metal oxide having a second reduced state, the second reduced state lower than the first reduced state; and
oxidizing the further reduced metal or metal oxide with air to produce N₂, O₂, heat, and the metal oxide oxygen carrier, the oxidation state of the metal oxide oxygen carrier having been substantially oxidized to the initial oxidation state.

2. The process of claim 1, wherein the first reduction reaction takes place in a fuel reactor (FR).

3. The process of claim 2, wherein the second reduction reaction takes place in a dip leg of a fuel reactor cyclone.

4. The process of claim 2, wherein the second reduction reaction takes place in a metal oxide return line of an air reactor loop seal.

5. The process of claim 2, wherein the second reduction reaction takes place in a fuel reactor loop seal.

6. The process of claim 1, wherein the hydrocarbon fuel is injected with steam.

7. The process of claim 6, wherein the steam is injected downstream of the hydrocarbon fuel.

8. The process of claim 1, wherein the hydrocarbon fuel is a liquid hydrocarbon fuel, pre-processed in a fuel rectifier to generate synthesis gas.

9. The process of claim 1, the metal oxide oxygen carrier comprising copper oxide and a reforming metal.

10. The process of claim 9, the reforming metal comprising nickel, cobalt, or iron.

11. The process of claim 6, wherein the ratio of steam to hydrocarbon fuel is varied to select the H₂:CO ratio.

12. The process of claim 6, wherein the ratio of steam to hydrocarbon fuel is varied according to the metal oxide reduction in the fuel reactor.

13. The process of claim 6, wherein the hydrocarbon/steam injection at a first location is held constant, and the hydrocarbon/steam injection at a second location is varied.

14. The process of claim 13, wherein the hydrocarbon/steam injection at the second location is optimized to overcome the Knudsen diffusion limit.

15. An oxygen carrier for a chemical looping combustion process, comprising a copper oxide and a reforming metal.

16. The oxygen carrier of claim 15, the reforming metal comprising nickel, cobalt, or iron.
